(19) United States
(12) Patent Application Publication
(10) Pub. No.: US 2003/0131479 A1
(43) Pub. Date: Jul. 17, 2003

(54) Run cutter

(76) Inventor: Forest E. Kinnaman, Deepwater, MO (US)

Correspondence Address: Forest E. Kinnaman, 1120 SE Hwy Z, Deepwater, MO, 64740, US

(21) Appl. No.: 10/047,242

(22) Filed: Jan. 14, 2002

(51) Int. Cl. B26B 29/06

(52) U.S. Cl. 30/170

(57) ABSTRACT

A device to aid painters in the repair of runs, drips or other raised imperfections on painted surfaces. The device includes a blade that allows the painter to shave off the dried drip in one or several passes. Rollers support the device on the painted surface and a threaded adjustment allows the user to control depth of the material shaved off. The device can be used on any surface and with any coating but finds particular applications on highly visible paint surfaces such as cars.

### BACKGROUND

When applying coatings such as paint or varnish to a surface it is common to get excess paint on some areas such as corners and edges and when this occurs the excess will often form a drip, run or other raised imperfection. Once the run has dried it is necessary to remove the excess coating to get the correct appearance on the surface. It is common practice currently to use sandpaper or a paint file to sand down the excess coating so that the area can be re-coated. The problem with sanding or filing is that usually the thinner coating surrounding the run gets removed first. This commonly occurs using hand sanding or machine sanding techniques. Continued sanding to remove the run then will remove any undercoats from the surrounding area. The result is an area that requires substantial effort and possibly more then one additional application of coating to correct. Even though the area damaged may be small, each application of coating requires another period of dry time that can substantially delay the entire project. Any attempt to speed up the repair by applying a thick coat to the area can result in a reoccurrence of the run problem. Another common approach to removing a drip is to hold a razor blade in the hand and attempt to carefully shave the excess paint off. The problem with this approach is that it takes a very steady hand to successfully shave off just the right amount of paint. Often the result is that a gouge is created and must be repaired.

### SUMMARY OF THE INVENTION

The device allows the user to remove the dried run without affecting areas of coating surrounding the run. An adjustable blade shaves off the excess coating of the run or drip in one or several passes. Rollers aid the user in maintaining a constant height during each pass, while threaded adjustment allows the user to control the blade height of each pass such that a run or drip can be removed without affecting the surrounding area of coating. The process can then be finished by polishing the coating in the area of the repair or by applying a thin masking coat to the area. The result is a run repair device that greatly accelerates the process of correcting runs by reducing damage to the surrounding coating and by reducing the application of correcting coating and by greatly increasing the precise control of excess paint removal.

### BRIEF DESCRIPTION OF THE DRAWINGS

FIG. 1 shows a view of the device

FIG. 2 shows a second view of the device

FIG. 3 shows a second embodiment of the device

### DETAILED DESCRIPTION OF THE PREFERRED EMBODIMENT

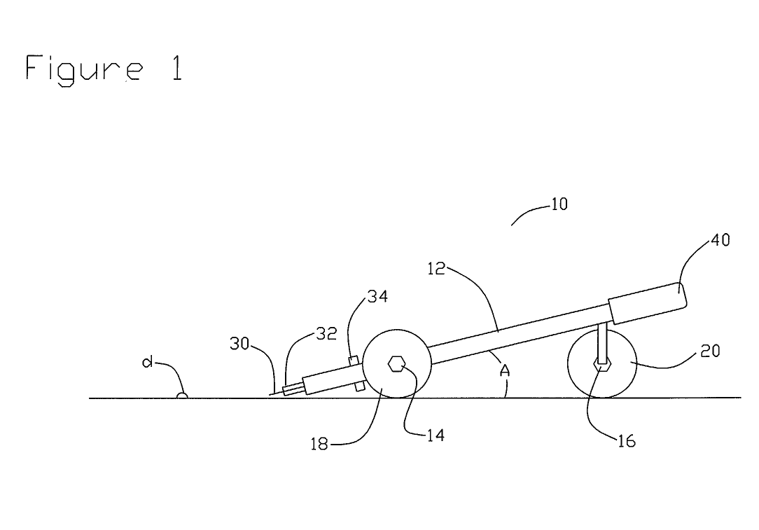

FIG. 1 shows a detailed drawing of the device (10). A frame (12) holds a front axle (14) and a rear axle (16). The front axle supports a pair of rollers (18), the rear axle (16) supports a single roller (20). Replaceable blade (30) is held by a holder (32). Blade (30) is held at an angle (A in FIG. 1) of 15 to 30 degrees relative to the coated surface. The holder (32) and blade (30) can be moved by a threaded adjuster (34). The angle of the blade (30) is critical to effective shaving of the paint run.

FIG. 1 also shows a drip (d) on the surface that the device rests on. A pad (40) can be used to improve the ergonomic feel of the device (10) when in use and as a safety cover for the blade (30) when the device is not in use.

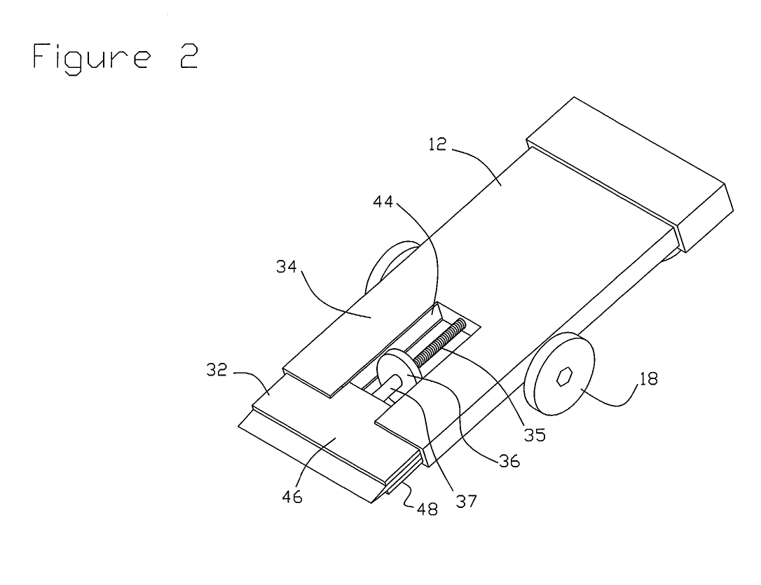

FIG. 2 shows details of the threaded adjuster (34), which includes a section of fixed thread (35). A thumb nut (36) can be rotated to extend the blade or to retract it. One end of spacer (37) is fixedly attached to the blade holder (32) and the thumb nut (36) is rotatably attached to the other end of spacer (37). The portion of the frame (12) holding the blade (30) forms a track (44) that tightly holds the upper (46) and lower (48) leaf of the blade holder (32) against the blade (30) clamping it in place.

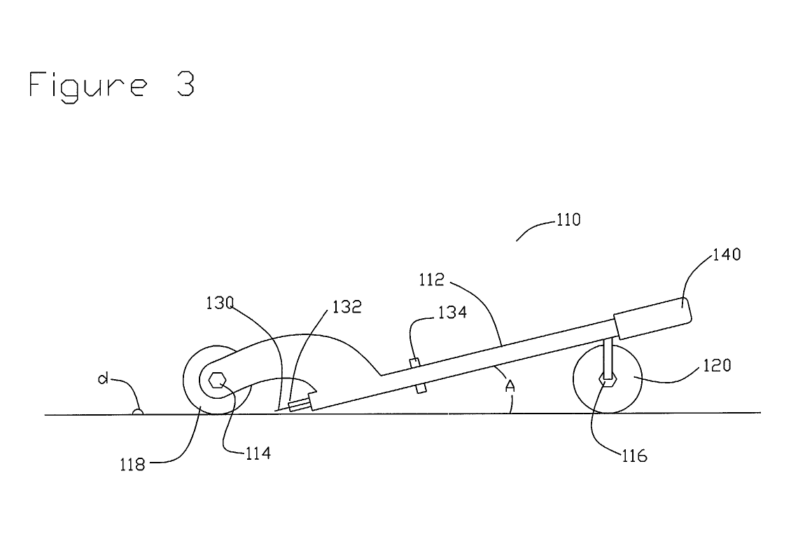

FIG. 3 shows an alternative embodiment of the device with like structure numbered 100 higher then in the first embodiment. In this embodiment the frame (112) has been altered so that the front axle (114) and front wheels (118) are in front of the blade (130) and blade holder (132). The back axle (116) and back wheel (120) are mounted close to the ergonomic handle (140). The angle (A) and threaded adjuster (134) are the same as in the first embodiment.

Referring back to the embodiment of FIGS. 1 and 2, in operation, when the painter discovers a run that has dried on a painted surface, the painter adjusts the depth of the blade (30) by rotating threaded adjuster (34). This action pulls the blade (30) back into the body of the device. The painter can then test the device setting by placing it on the painted surface near the drip to be removed. Often the surface may be curved so one setting will not always work correctly. On a first shaving pass only the top of the drip will be removed. The painter can then reverse the threading motion to extend the blade (30) to shave off more paint from the drip. With each pass the blade is extended a little more. The device gives the painter as much control of the process as the painter wants.

To those skilled in the art to which this invention relates, many changes in construction and different embodiments will make themselves known without departing from the spirit and scope of the invention. The disclosure and the description herein are purely illustrative and are not intended to be limiting.

What is claimed is:

1. A handheld run cutter for use in removal of excess dried coating from a dried coating surface comprising;
A frame having a front and back end, a first roller means supporting the front of the frame and a second roller means supporting the back of the frame, said first and second roller means supporting said frame movably on said surface; a blade adjustably mounted to said frame, said blade held at a distance from said coated surface, threaded means for adjusting the distance of said blade relative to said surface:

2. The handheld run cutter of claim 1 wherein said first and second roller means include a roller mounted on an axle.

3. A handheld run cutter for use in removal of excess dried coating from a dried coating surface comprising;
A frame having a front end and a back end, a first roller means supporting the front of the frame and a support means supporting the back end of the frame, said first roller means and said support means supporting the frame movably on the surface; a blade adjustably mounted to said frame, said blade held at a distance from said coated surface, threaded means for adjusting the distance of said blade from said coated surface.

4. The handheld run cutter of claim 3 wherein said support means includes a roller.
